(19) United States
(12) Patent Application Publication
(10) Pub. No.: US 2009/0245948 A1
(43) Pub. Date: Oct. 1, 2009

(54) CUTTING TOOL

(75) Inventor: Jiro MOTOMURA, Anjo-shi (JP)

Correspondence Address: BACON & THOMAS, PLLC, 625 SLATERS LANE, FOURTH FLOOR, ALEXANDRIA, VA, 22314-1176, US

(73) Assignee: AISIN AW CO., LTD., Anjo-shi (JP)

(21) Appl. No.: 12/389,146

(22) Filed: Feb. 19, 2009

(30) Foreign Application Priority Data
Mar. 27, 2008 (JP) 2008-083361
Jun. 6, 2008 (JP) 2008-149613

(51) Int. Cl. B26D 1/12

(52) U.S. Cl. 407/42

(57) ABSTRACT

A cutting tool, for cutting a workpiece of a non-ferrous metal with hard particles dispersed therein, includes a rake face, a relief face, and a cutting edge formed at the intersection of the rake face and the relief face. A distal end portion of the cutting tool including the cutting edge is composed of a diamond tip. The relief face is divided into a first relief face and a second relief face with a curved boundary ridge therebetween. The first relief face intersects the cutting edge, and the second relief face extends from the boundary ridge away from the cutting edge. A first relief angle, that is an angle between the first relief face and the rake face of the cutting tool, is larger than a second relief angle that is an angle between the plane of the second relief face and the rake face. The boundary ridge is formed on the diamond tip.

### INCORPORATION BY REFERENCE

The disclosure of Japanese Patent Application No. 2008-083361 filed Mar. 27, 2008 and the disclosure of Japanese Patent Application No. 2008-149613 filed Jun. 6, 2008, including their specifications, drawings and abstracts are incorporated herein by reference in its entirety.

### BACKGROUND OF THE INVENTION

1. Field of the Invention

The present invention relates to a cutting tool for cutting workpieces of a non-ferrous metal with hard particles dispersed therein.

2. Description of the Related Art

For example, copper-based bearing alloys, containing hard particles that act as an abrasion resistant material, are used for sliding bearings. As an example of such copper-based bearing alloys, copper alloy containing hard particles as an abrasion resistant material and a relatively large amount of lead (PB) has been widely used (see Japanese Patent Application Publication JP-A-7-179964). However, recent growing awareness of environmental problems has restricted the use of a large amount of lead. As a consequence, a demand has been created for alternative copper-based bearing alloys, which are lead-free or, alternatively, contain less lead.

In answer to the foregoing demand, lead-free copper-based bearing alloys have been developed as high performance sliding bearings, which are lead-free copper-based bearing alloys made of copper alloy containing hard particles of metal phosphide, metal boride, or metal carbide. Also recently developed are bearing alloys which are aluminum-based soft alloys containing hard particles.

Bearing alloys are shaped into sliding bearings, as designed, through grinding and polishing.

However, as such bearing materials are cut with a conventional cutting tool having a cutting edge formed with a diamond tip (see Japanese Patent Application Publication JP-A-2007-54945), the cutting is more difficult as compared to related-art copper-based bearing alloys containing lead, i.e their use results in reduced cutting accuracy and shorter life of the cutting tool. Improvement in cutting performance by use of a relatively large amount of lead is no longer an available option.

The above problem is not limited to bearing alloys. It is also encountered in cutting a workpiece made of a non-ferrous lead-free metal with hard particles dispersed therein.

### SUMMARY OF THE INVENTION

In order to solve the problem described above, the present invention has as its objective provision of a cutting tool that gives higher cutting performance and has higher durability in cutting a workpiece made of a non-ferrous lead-free metal with hard particles dispersed therein.

Thus, the present invention relates to a cutting tool for cutting a workpiece of a non-ferrous metal with hard particles dispersed therein. The cutting tool includes a rake face, a relief face, and a cutting edge formed at the intersection of the rake face and the relief face. A distal end portion of the cutting tool including the cutting edge is composed of a diamond tip. The relief face has a first relief face and a second relief face differing from the first relief face in angle, i.e. the second relief face intersects the second relief face at an angle greater than 0° and less than 180°. Thus, the first and second relief faces connect at a boundary ridge therebetween. The first relief face intersects the rake face with the cutting edge formed at a corner of that intersection, and the second relief face extends from the boundary ridge away from the cutting edge. A first relief angle that is an angle between the first relief face and the rake face of the cutting tool is larger than a second relief angle that is an angle between a plane defined by the second relief face and the rake face. The boundary ridge is formed on the diamond tip.

As described above, the cutting tool of the present invention has the relief face formed on the diamond tip and is divided into a first relief face and a second relief face which connect at the boundary ridge therebetween, and, thus, the boundary ridge is formed on the diamond tip. Accordingly, the cutting tool of the present invention provides good cutting performance and durability, even in cutting a workpiece made of a non-ferrous metal with hard particles dispersed therein.

Because the first relief angle of the first relief face relative to the cutting edge is larger than the second relief angle of the second relief face relative to the cutting edge, in the cutting operation, the first relief angle is the angle of the first relief face relative to the cutting direction and is smaller than the second relief angle of the second relief face relative to the cutting direction. The relatively large second relief angle of the second relief face (angled away from the cutting edge) prevents the relief face from making a hard contact with a cut face of the workpiece. Thus, the first relief angle of the first relief face can be set to be relatively small. The first relief face having the smaller first relief angle is formed behind the cutting edge as seen in the cutting direction. Therefore, compared with a case wherein the first relief angle and the second relief angle are identical, it is possible to increase the number of diamond particles and to strengthen the bond between the diamond particles that support from behind diamond participles present at the front end, in the cutting direction, forming the cutting edge, as seen in the cutting direction during the cutting operation. In other words, stress in the cutting direction on each of the diamond particles or each bond between the diamond particles is reduced and loss of diamond particles from the cutting edge is slowed.

Especially, when cutting a workpiece made of a non-ferrous metal with hard particles dispersed therein, collisions occur between the cutting edge and the hard particles. In this case, hard particles directly collide with the diamond particles forming the cutting edge, for example, especially in the case of cutting lead-free bearing alloys containing dispersed hard particles. As a result, there is a higher probability that the diamond particles may come off. Therefore, the advantageous effect resulting from making the relief angle of the first relief face relatively small is highly significant.

In the present invention, the boundary ridge, at the intersection of the first and second relief faces, is formed on the diamond tip. Therefore, lower production cost, longer life, and better cutting performance of the cutting tool are achieved, compared with like cutting tools wherein the boundary ridge is disposed rearward of the diamond tip as seen in the cutting direction, that is, as described below, disposed on a back-metal portion supporting the diamond tip on a tool body. The lower production cost is attributed to the fact that the amount of grinding necessary to form the diamond tip can be reduced by providing the boundary ridge on the diamond chip while making the cutting tool.

The reasons why disposition of the boundary ridge on the diamond tip leads to longer life and better cutting performance will now be explained.

The cutting tool of the present invention slows the loss of diamond particles by making the relief angle of the first relief face relatively small as described above. However, the progress of abrasion of the cutting edge with time of use cannot be completely stopped. If the boundary ridge is disposed on the diamond tip during the progress of the abrasion of the cutting edge, once the abrasion has progressed to a certain level, wherein the abraded area extends over the entire first relief face, another form of abrasion, referred to flank abrasion, then appears in which the shape of the first relief face is gradually changed to the shape of the cut face of the workpiece. Once abrasion has further progressed to exceed the length of the first relief face, the growth of the abrasion significantly slows. At the same time, the area supporting diamond particles from behind in the distal end of the cutting edge increases compared with its early stage; this further slows down the progress of the abrasion (flank abrasion). It might be expected that the rate at which the first relief face comes into contact with the cut face will increase; however, loss of cutting quality can be prevented because the first relief face is limited to a relatively small area by the presence of the boundary ridge.

On the other hand, the above-described effect is not obtained if the first relief face is extended to cover the whole diamond tip and the boundary ridge is disposed on a border area between the diamond tip and a metal backing or below.

As described above, the present invention can provide a cutting tool with better cutting performance and durability when cutting a workpiece made of a non-ferrous metal with hard particles dispersed therein.

### BRIEF DESCRIPTION OF THE DRAWINGS

FIG. 1 is a perspective view of a cutting tool according to a first embodiment;

FIG. 2 is a partial elevational view of the cutting tool of the first embodiment;

FIG. 3 is a partial elevational view of the cutting tool of the first embodiment, showing the rake angle and relief angle of the cutting tool according to the first embodiment;

FIG. 4 is a diagram of the structure of the diamond tip according to the first embodiment;

FIG. 5 is a plan view of the cutting edge seen from the rake face according to the first embodiment;

FIG. 6 is a partial elevational view of a comparative cutting tool, showing a rake angle and a relief angle of a cutting tool according to a first comparative example;

FIG. 7 is an elevational view, showing a rake angle and relief angle of a cutting tool according to a second comparative example;

FIG. 8 is an elevational view, showing rake angle and relief angle of a cutting tool according to a third comparative example; and

FIG. 9 is a graph of the amount of abrasion of the cutting tool versus cutting distance for cutting tools according to first and second embodiments of the invention and a first comparative example.

### DESCRIPTION OF THE PREFERRED EMBODIMENTS

A bearing alloy, in general, has superior burnout resistance, has a low abrasion coefficient, and is also softer, as compared with a non-ferrous alloy with hard particles of an anti-abrasion material contained therein. The inventor, through studies of cut workpieces made of such a non-ferrous metal with hard particles dispersed therein and the worn cutting edge of the diamond tip of a conventional tool used to cut same, discovered the following problems:

1: Related-art bearing alloys contain a large amount of lead, which lead functions as a solid lubricant and reduces the impact force of collision between a cutting edge of a diamond tip of a cutting tool and hard particles in the workpiece during cutting of the workpiece.

2: In lead-free bearing alloys that contain bismuth (a similar metal next to lead in the periodic table), instead of lead, and that contain a smaller amount of bismuth compared with the amount of lead alloy in the related-art bearing alloy, bismuth is less effective as a solid lubricant and less effective in reducing the impact force of the collision between the cutting edge and the hard particles, as compared to lead.

The inventor has also discovered that abrasion streaks (flank abrasion), seen in a worn diamond tip after cutting such a workpiece result from fatigue failure of bonding of the diamond particles caused by the main component of force working on the diamond tip. The present invention slows the development of the fatigue failure phenomenon.

In a cutting tool of the present invention, it is preferable that the first relief angle β1, between the first relief surface 131 and the rake face 12, be in a range of 83° to 88°. In other words, in cutting, when the rake face is at an angle of 90° to the cutting direction (that is, the rake face is at an angle of 0° relative to a direction B perpendicular to the cutting direction), the first relief angle α1, between the first relief face and the cutting direction, is preferably in a range of 2° to 7°.

While a related-art cutting tool usually has a relief angle β that is relatively small and no more than 79° and the relief angle α is relatively large, no less than 11°, the cutting tool of the present invention, designed for a specific use, has the relief angles divided into two, as described above. The first relief angle β1 is preferably made larger than the related-art relief angle and is in the above-determined range. This enables an increase in the area of diamond particles that support diamond particles in the cutting edge and in contact with a workpiece during cutting, and suppression of loss of diamond particles. If the first relief angle β1 exceeds 79° (the first relief angle α1 is less than 2°), the first relief face problematically tends to contact the cut surface of the workpiece when cutting the inner cylindrical surface of a cylindrical workpiece. Also, when the first relief angle β1 is less than 83° and the first relief angle α1 exceeds 7°, it is difficult to fully gain the above-described advantages.

It is also preferable that the second relief angle β2 be in a range of 79° plus/minus 2°. In other words in a cutting operation, when the rake face is at an angle of 90° to the cutting direction “A” (that is, the rake face defines an angle of 0° relative to direction B perpendicular to the cutting direction), the second relief angle α2, that is the angle between the second relief face and the cutting direction is preferably is in a range of 11° plus/minus 2°. This significantly reduces the possibility that the second relief face will come into contact with a cut face of a workpiece. The second relief angle β2 is more preferably in a range of 79° plus/minus 30′ and the second relief angle α2 is more preferably in the range of 11° plus/minus 30′.

It is also preferable that the cross sectional shape of the cutting edge be a curved shape with a radius of curvature of 10 μm to 75 μm. More specifically, seen in cross section (the cross section parallel to the rake face and perpendicular to the cutting face), a cutting edge at a corner portion formed on a line of intersection between a rake face and a relief face preferably has a radius of curvature in the above predetermined range. In this case, the curved surface is formed of multiple diamond particles whose diameter is sufficiently smaller than the above radius of curvature. Thus, the possibility that a plurality of diamond particles will contact a workpiece at the same time during cutting is increased. As a result, the loss of diamond particles is slowed. When the radius of curvature is less than 10 μm, the number of diamond particles simultaneously in contact with the workpiece during cutting decreases, and the rate of loss of diamond particles is thereby increased. On the other hand, when the radius of curvature exceeds 75 μm, the cutting resistance problematically increases.

It is also preferred that the workpiece be formed of a lead-free copper-based bearing alloy containing Cu: 75 to 95 percent by weight; Bi: 1 to 15 percent by weight; and hard particles composed of metal phosphide, metal boride, or metal carbide: 1 to 10 percent by weight. When lead-free copper-based bearing alloys are cut with a related-art cutting tool designed for cutting conventional copper-based bearing alloy, as described above, the result is less cutting accuracy and shorter life of the cutting tool. However, the use of the cutting tool of the present invention can solve such problems to a significant extent.

It is also preferred that the diamond tip be made of sintered material formed by sintering diamond particles with an average particle diameter (D50) of 0.2 μm to 1.6 μm, to further improve cutting performance and durability when cutting a workpiece made of a non-ferrous metal with hard particles dispersed therein.

When cutting a workpiece of a non-ferrous metal with hard particles dispersed therein, the frequency of loss of diamond particles, by collision between the hard particles in the workpiece and the diamond tip of the cutting tool, becomes higher as compared with cutting, for example, materials with lead such as lead-containing copper-based bearing alloys. It is difficult to completely avoid this phenomenon relating to the loss of diamond particles. A concave portion corresponding to the size of the diamond particles is formed at each site on the cutting edge where a diamond particle has come off. As the number of such concave portions increases, the shape of the cutting edge becomes more distorted. This leads to lower cutting performance.

In general, diamond tips of relatively large diamond particles with an average particle diameter (D50) of 2 μm to 10 μm are used. However, in the present invention, using a diamond tip made by sintering very small diamond particles with an average particle diameter (D50) of 0.2 μm to 1.6 μm, the degree of the distortion of the cutting edge shape is less even if the loss of the diamond particles occurs at the same rate. In other words, a reduction in the average particle diameter of diamond particles, in accordance with the present invention, further improves cutting performance and durability.

Average particle diameter D50 is defined as “a particle diameter at which accumulated mass from a small particle diameter side reaches 50%” in a particle size distribution diagram whose horizontal axis indicates particle diameters and whose vertical axis indicates percentage by mass of particles corresponding to respective particle diameters. The average particle diameter D50 can be measured by a laser diffraction particle size distribution measurement method.

Also, from the viewpoint of stable cutting it is preferred that a rake angle, i.e. the angle between the rake face and the direction B perpendicular to cutting direction A of the cutting tool be in a range of +5° to −10°. When the rake angle is a negative angle exceeding −10°, a problem may occur that stress applied to a workpiece rapidly rises, resulting in a rough surface on the cut face of the workpiece. On the other hand, if the rake angle exceeds +5° the result is a loss of shear strength of the cutting edge, tending to cause loss and breakage of the cutting edge.

The hard particles contained in the workpiece advantageously have an average particle diameter (D50) in a range of 1 μm to 70 μm. More specifically, when the average particle diameter of the hard particles contained in the bearing alloy are within that range, particle diameters of the diamond particles in the cutting tool are sufficiently smaller than those of the hard particles, and therefore, the effect of the present invention is more evident. On one hand, when the average particle diameter of the hard particles contained in the bearing alloy is less than 1 μm, the result is poorer performance of the bearing alloy. On the other hand, when the average particle diameter exceeds 70 μm, the effect of the present invention may be lost.

It is also preferred that the distance between the boundary ridge and the rake face be in a range of 150 to 450 μm. A distance of less than 150 μm reduces the advantageous effect of the first relief face, and a distance exceeding 450 μm fails to slow progress of the flank abrasion, and degrades cutting performance.

### First Embodiment

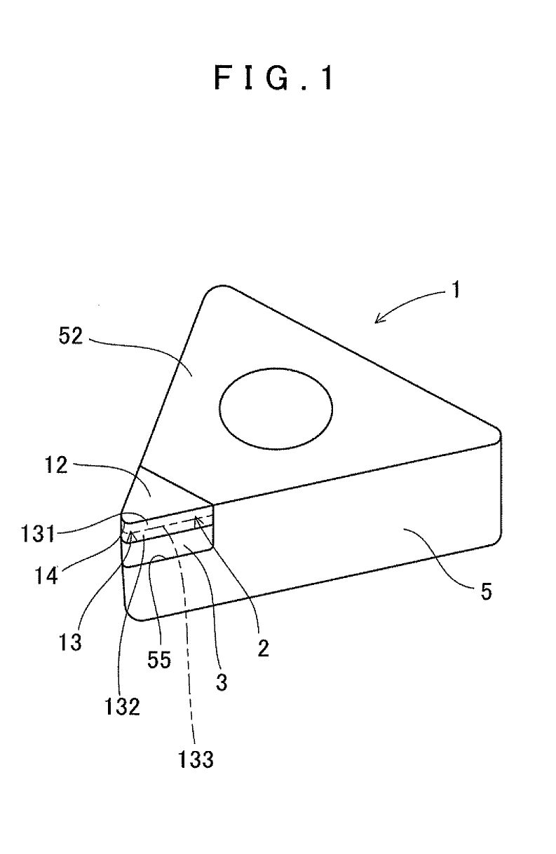

A cutting tool according to a first embodiment of the present invention will now be described with reference to FIG. 1 through FIG. 4.

In this first embodiment, lead-free copper-based bearing alloy containing the following components is chosen as a workpiece with hard particles dispersed therein: Cu: 75 to 95% by weight; Bi: 1 to 15% by weight; and hard particles of metal phosphide, metal boride, or metal carbide: 1 to 10% by weight.

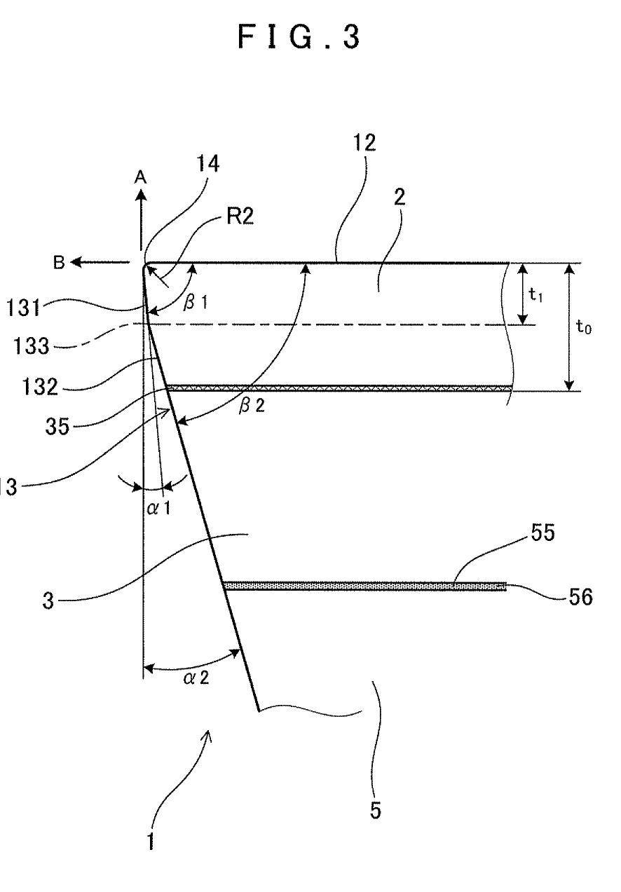

As shown in FIG. 1, a cutting tool 1 for cutting the workpiece includes a rake face 12, a relief face 13, and a cutting edge 14 disposed on the line of intersection between the rake face 12 and the relief face 13. A distal end portion including the cutting edge 14 is composed of a diamond tip 2. The relief face 13 includes a first relief face 131 and a second relief face 132, which differ in angle and which connect at a boundary ridge 133 therebetween. The boundary ridge 133 is disposed on the diamond tip 2. The first relief face 131 is in contact with the cutting edge 14, while the second relief face 132 extends from the boundary ridge away from the cutting edge 14. As shown in FIG. 3, the first relief face 131 defines a first relief angle β1 relative to the rake face 12, and the first relief angle β1 is larger than a second relief angle β2 that the second relief face 132 defines relative to the rake face 12. When the rake face 12 is perpendicular to cutting direction A, the first relief angle α1 that the first relief face 131 defines relative to a cutting direction A of the cutting tool 1 is smaller than a second relief angle α2 that the second relief face 132 defines relative to the cutting direction A of the cutting tool 1.

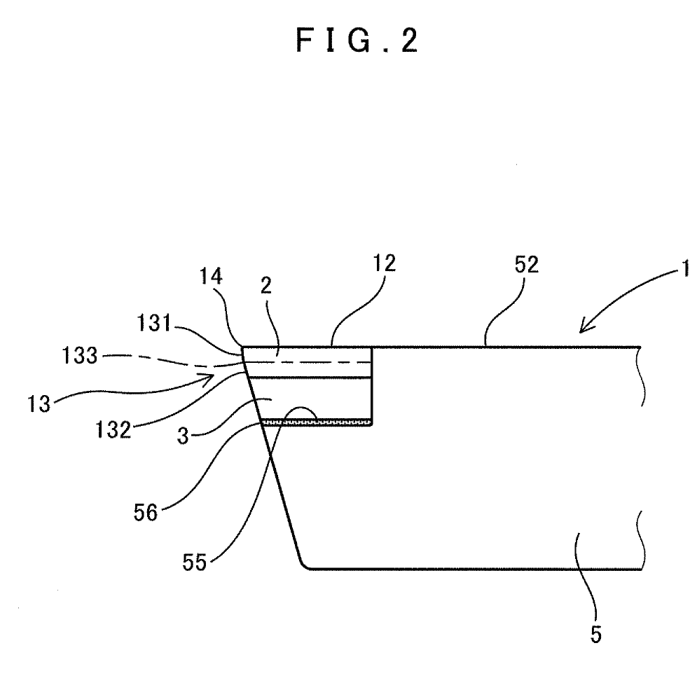

The cutting tool 1 of the first embodiment, as shown in FIGS. 1 and 2, has an installation face 55 approximately parallel to a rake face 52 of a tool body 5 that is triangular in shape and is formed as a recess in a corner portion on the rake face 52. The diamond tip 2 is formed on a metal backing (back metal) 3 which, in turn, is disposed on the installation face 55.

As FIGS. 1 and 2 show, the diamond tip 2 is attached to the metal backing 3 to form a double-layer structure. The metal backing 3 is made of a WC—Co alloy (cemented carbide), which is widely used for metal backing.

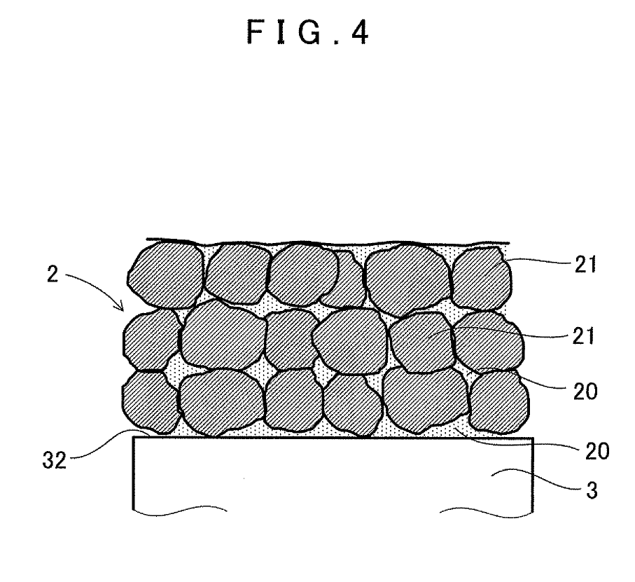

As FIG. 4 shows, the diamond tip 2 is made by mixing diamond particles 21 of an average particle diameter (D50) of 2 to 10 μm with a Co catalyst 20, and then sintering under high temperature and high pressure while set on a rake face side surface 32 of the metal backing 3. The Co catalyst 20 from the diamond tip 2 and WC—Co diffuse to form a diffusion layer 35 (see FIG. 3).

Also as shown in FIG. 3, the double-layer structure is disposed on the tool body 5 with the rear (lower) face of the metal backing 3 and the installation face 55 and joined with a brazing filler 56.

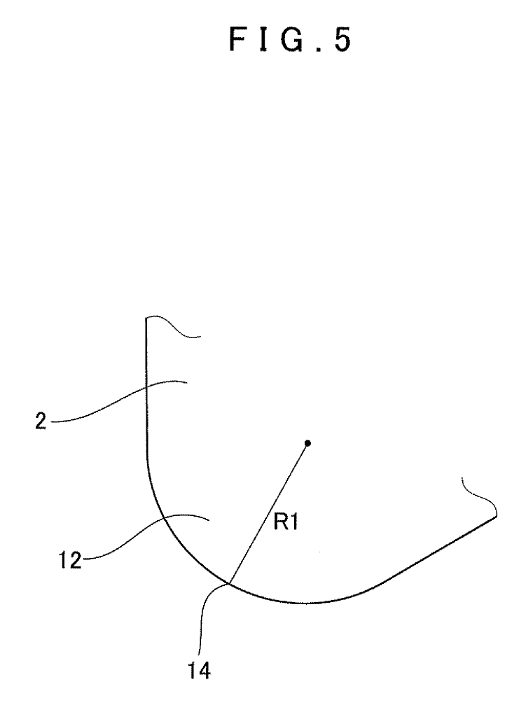

As shown in FIGS. 1 and 5, the rake face 12 of the diamond tip 2 has a roughly triangular shape and has an arc-shaped corner portion forming the cutting edge 14 which has a curved shape.

As FIG. 5 shows, the cutting edge 14 has a curved shape with a radius of curvature R1 preferably within the range of 0.2 to 1.6 mm. In this embodiment, the radius of curvature R1 is 0.8 mm.

As shown in FIG. 3, the first relief face 131 defines a first relief angle β1 of 85° relative to the rake face 12 and the second relief face 132 defines a second relief angle β2 of 79° relative to the rake face 12. When the rake face 12 is perpendicular to the cutting direction A of the cutting tool 1, the first relief angle α1 of the first relief face 131 is 5°, and the second relief angle α2 of the second relief face 132 is 11°.

As shown in FIG. 3, the rake angle which the rake face 12 defines relative to a direction B, perpendicular to the cutting direction of the cutting tool 1, is 0° on a tool having a roughly triangle shape.

As also shown in FIG. 3, the cross section of the cutting edge 14, perpendicular to the rake face 12, has a curved shape with a radius of curvature R2 of 10 to 75 μm.

In this first embodiment, the thickness of the diamond tip 2 t₀ is preferably in the range of 200 to 550 μm. The boundary ridge 133 is disposed at a position a distance t₁ from the rake face 12. The preferred value for t₁ is 150 to 450 μm.

A cutting tool 1 with the above-described configuration of the first embodiment was used to cut lead-free copper-based bearing alloy (Taiho Kogyo Co., Ltd. Product No: HB-200X). The result was that the cutting performance and life of the tool were roughly the same as those obtained when cutting a copper-based bearing alloy containing lead using a conventional cutting tool.

In the first embodiment, the tool body 5 is described as having a triangular shape, but it is possible to employ other shapes, such as a rectangular shape.

For purposes of comparison with the first embodiment, the following three types of cutting tools 91 through 93 (first to third comparative examples) were prepared and performance comparisons were made.

### FIRST COMPARATIVE EXAMPLE

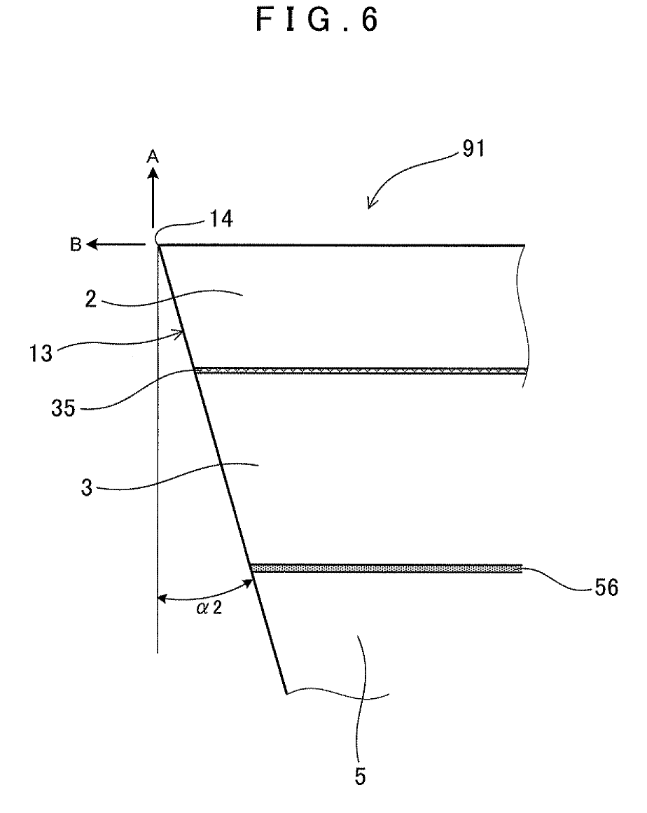

The cutting tool 91 of the first comparative example, is shown in FIG. 6 as including a relief face 13 with one single angle relative to the diamond tip 2, a metal backing 3, and a tool body 5, the single angle being defined as α2 (11°), that is, the same angle as the second relief face 132 of the first embodiment. In other words, the relief face is a single, continuous, planar surface throughout, i.e. without the boundary ridge 133 of the first embodiment Moreover, the shape of the cutting edge 14 was left sharp after polishing, without being formed into a curved surface, as in the case of the first embodiment.

### SECOND COMPARATIVE EXAMPLE

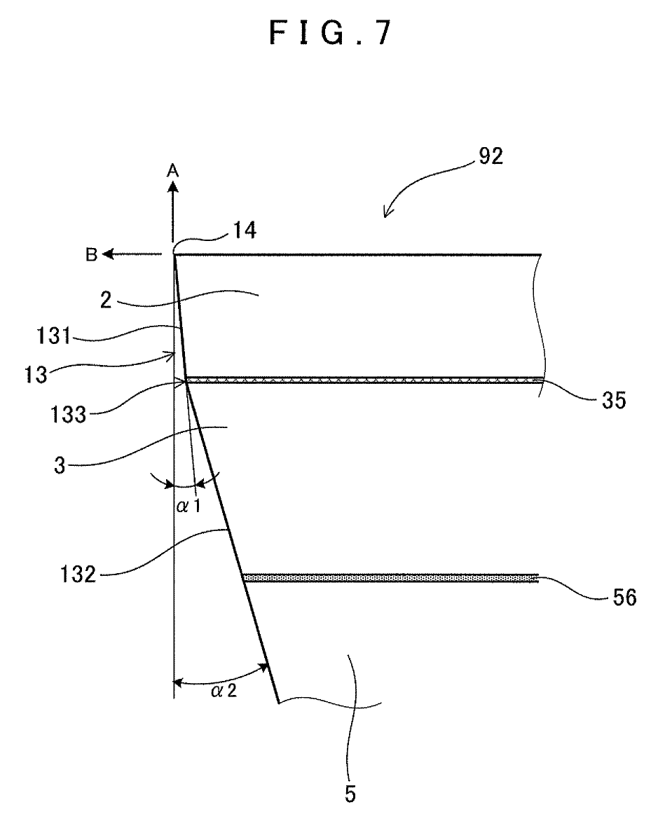

The cutting tool 92 of the second comparative example is shown in FIG. 7 as including a relief face 13 which is divided into a first relief face 131 and a second relief face 132 which intersect at a boundary ridge 133 therebetween. However, the boundary ridge 133 is formed in the diffusion layer 35 provided between the diamond tip 2 and the metal backing 3 rather than on the diamond tip 2 as in the first embodiment. As in the first embodiment, the first relief angle α1 of the first relief face 131 and the second relief angle α2 of the second relief face 132 are 5° and 11°, respectively. In addition, the shape of the cutting edge 14 was left sharp after polishing, without being formed into a curved surface, as in the case of the first embodiment.

### THIRD COMPARATIVE EXAMPLE

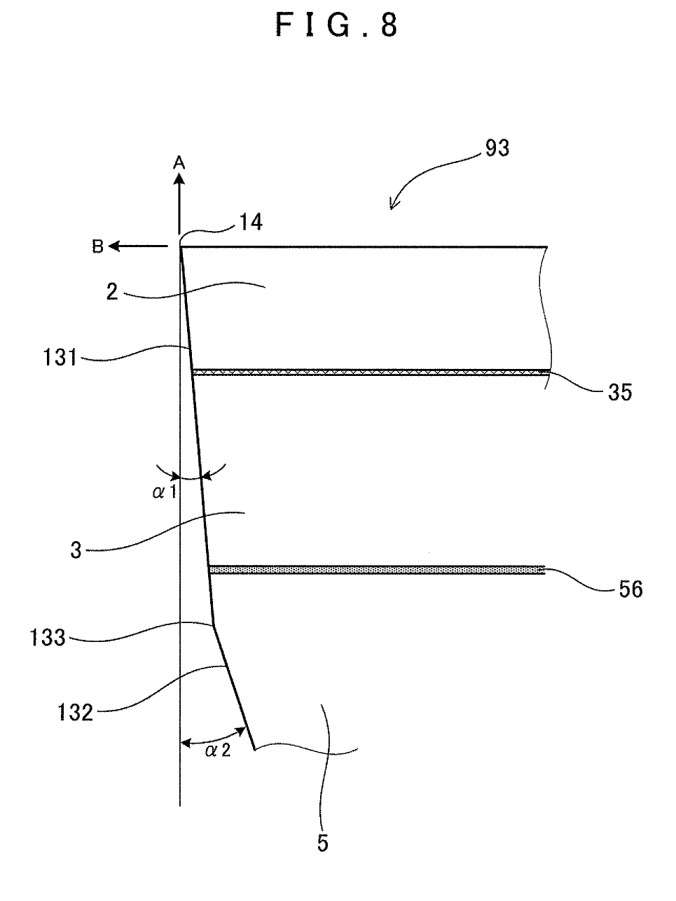

The cutting tool 93 of the third comparative example is shown in FIG. 8 as including a relief face 13 divided into a first relief face 131 and a second relief face 132 which intersect at a boundary 133 therebetween. The boundary 133 is lower than in the previously described embodiment and is disposed, not on the diamond tip 2 or metal backing 3 but, rather, on the tool body 5. As in the first embodiment, the first relief angle α1 of the first relief face 131 and the second relief angle α2 of the second relief face 132 are 5° and 11°, respectively. Moreover, the shape of the cutting edge 14 was left sharp after polishing, without being formed into a curved surface, as in the case of the first embodiment.

The following results of the comparisons between the cutting tools 91 to 93 of the first to third comparative examples and the cutting tool 1 of the first embodiment will now be described.

### Initial Loss

In the first to third comparative examples (FIGS. 6 to 8), initial loss in mass of the diamond tip occurs at a relatively earlier stage than in the first embodiment (FIG. 3). It is assumed that this phenomenon is due to the difference between the cross-sectional shape of the cutting edge 14 of the first embodiment and that of the comparative examples. This indicates that forming the cutting edge 14 to have a certain level of curvature, as seen in a top plan view of the tool body, effectively delays the initial loss and thereby prolongs useful service life.

### Progress of Abrasion After Initial Loss

The cutting tool of the first comparative example (FIG. 6) showed the most rapid progress of abrasion after the initial loss, the cutting tools of the second and third comparative examples (FIGS. 7 and 8) follow, while the first embodiment exhibited the slowest progress of abrasion after the initial loss. It is assumed that the difference between the first comparative example and the second and third comparative examples is attributed to the difference in the relief angle of the relief face directly connected to the cutting edge 14, and the difference between the second and third comparative examples and the first embodiment is attributed to the fact that the boundary ridge 133 is disposed on the diamond tip 2.

### Grinding In Cutting Tool Production

Grinding is conventionally done in two steps in cutting tool production. However, in the case of the first comparative example, there was no need to perform the second step of grinding, resulting in a lower cost. In the second and third comparative examples, the first relief face 131 has a larger area than that of the first embodiment, which increases the cost of the second grinding step.

### Contact Length of Relief Face

Due to abrasion on a diamond tip, the shape of a relief face gradually changes into an arc shape conforming to the inner periphery of a workpiece, in the cutting direction. The “contact length” of the relief face is that length of the arc where the relief face and the cut face of the workpiece are in contact. Conventionally, as the contact length of the relief face becomes shorter, deterioration of the cut face of the workpiece slows. However, in the first embodiment, because the first relief angle is small, the rate at which the contact length of first relief face with the cut face of the workpiece lengthens is faster. However, deterioration of the quality of the cut face attributable to the longer contact length of the relief face is minimized because the first relief face is limited to a small area, and also because, once the contact length of the relief face caused by abrasion has extended to the boundary ridge, the growth of the contact length of the relief face significantly slows. In both examples, i.e., in the second comparative example in which the boundary ridge is disposed at the border between the diamond tip 2 and the metal backing 3, and in the third comparative example in which the boundary ridge is disposed to the rear of that border, the contact length of the relief face increases faster as compared with the first embodiment and, as a result, the effect of the first embodiment cannot be obtained. Further, the first embodiment avoids deterioration of the quality of the cut face of the workpiece caused by adhesion. This is because, compared with the metal backing (back metal) 3, the diamond tip 2 has lower affinity (less adhesion) to the material of the workpiece with which it is in contact. In contrast, in the second and third comparative examples there was more deterioration of the quality of the cutting face caused by adhesion, because the workpiece and the metal backing have high affinity and more contact with each other

As described above, with all things considered, it is found that the cutting tool 1 of the first embodiment of the present invention has longer life and relatively lower production cost, and is highly superior to the cutting tools of the first to third comparative examples.

### EXPERIMENTAL EXAMPLE

A second embodiment of a cutting tool in accordance with present invention (not shown in drawings) was prepared having a diamond tip 2 formed of diamonds with an average particle diameter (D50) of 0.2 to 1.6 μm. Using the cutting tools of this second embodiment, the first embodiment (FIG. 3) and the first comparative example (FIG. 6), an experiment to compare abrasion rates was conducted. The characteristics of the cutting tool of the second embodiment, including angles of the relief face, were the same as those of the first embodiment, except for the average particle diameter of the diamond particles.

The workpiece used in this Experimental Example was a lead-free copper-based bearing alloy (Taiho Kogyo Co., Ltd. Product No: HB-200X) containing: Cu: 87 plus/minus 3% by weight; Bi: 6.5 plus/minus 1.5% by weight; and hard particles of iron phosphide with an average particle diameter (D50) of 25 μm: 2.5 plus/minus 1.0% by weight.

The experiment was conducted by measuring the amount (μm) of abrasion of a cutting edge in repeated cutting of the workpiece. Thus, this example was an attempt to determine the relationship between an accumulated cutting distance (km) and the amount (μm) of abrasion of a cutting tool.

The cutting parameters were as follows: cutting speed 300 m/minute; feed 0.10 mm/rev; machining allowance 0.15 mm; and R1 (nose R) 0.8 mm.

The abrasion amount was defined as a dimension in a direction orthogonal to the rake face 12, and also defined as the greatest depth of worn (damaged) sites on the relief face, using the position of the rake face 12 as a reference (zero).

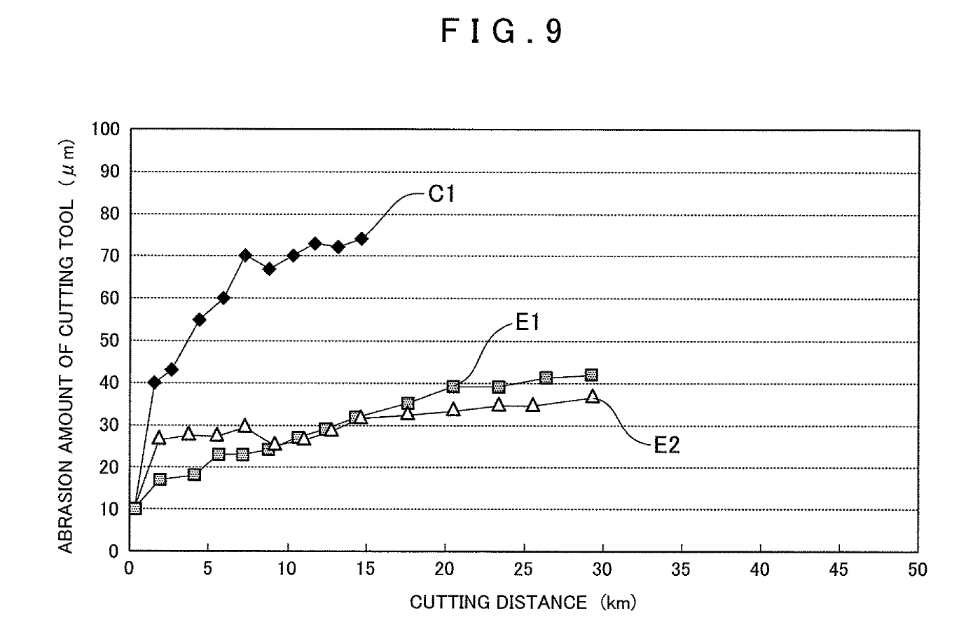

The results are shown in FIG. 9. In FIG. 9, the horizontal axis represents cutting distance (km) and the vertical axis represents amount (μm) of abrasion. Reference numeral E1 indicates the first embodiment, C1 indicates the first comparative example, and E2 indicates the second embodiment.

As is clear from FIG. 9, in the first and second embodiments (E1 and E2) according to the present invention, abrasion of a cutting tool progresses extremely slowly compared with that of the first comparative example (C1).

Although there was no major difference between the first embodiment (E1) and the second embodiment (E2), the results were slightly different.

More specifically, in the second embodiment (E2), fine diamond particles (D50 of 0.2 to 1.6 μm) come off due to collision with the hard particles (D50 of about 20 μm) of the workpiece in an initial abrasion stage (a cutting distance of 0 to 2 km). However, after the initial abrasion has progressed to a certain level (a cutting distance of 2 to 15 km), destruction by collision with the hard particles becomes less progressive and abrasion therefore slows. This is because the number of diamond particles that support a load in the principal direction increases.

On the other hand, in the first embodiment (E1), diamond particles have a larger particle diameter (D50 of 10 to 75 μm) than in the second embodiment (E2). Therefore, contact areas between the diamond particles are reduced throughout the diamond tip, resulting in less catalyst present in the areas of contact between the particles, and strength is increased. Thus, destruction due to collision with the hard particles (D50 of about 20 μm) progresses more slowly in an initial abrasion stage (a cutting distance of 0 to 2 km) as compared with the second embodiment (E2). However, after the abrasion has progressed to a certain extent (a cutting distance of 10 to 15 kn), abrasion progresses somewhat faster than in the second embodiment (E2). This is because the amount of abrasion that is caused every time a particle is lost becomes larger because of the larger diameter and smaller number of diamond particles contained in the edge of the diamond tip. However, because the relief angle is smaller than that of the first comparative example (C1), abrasion is sufficiently slow in the first embodiment (E1).

The invention may be embodied in other specific forms without departing from the spirit or essential characteristics thereof The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

What is claimed is:

1. A cutting tool for cutting a workpiece of a non-ferrous metal with hard particles dispersed therein, the cutting tool comprising:
a rake face;
a relief face intersecting the rake face; and
a cutting edge formed at the intersection of the rake face and the relief face, and wherein:
a distal end portion of the cutting tool including the cutting edge is composed of a diamond tip,
the relief face is divided into a first relief face and a second relief face intersecting the first relief face at an angle, the first and second relief faces being connected with a curved boundary ridge therebetween, the first relief face intersecting the cutting edge, and the second relief face extending from the boundary ridge away from the cutting edge,
a first relief angle, that is an angle between the first relief face and the rake face of the cutting tool, is larger than a second relief angle, that is an angle between the second relief face and the rake face, and
the curved boundary ridge is formed on the diamond tip.

2. The cutting tool according to claim 1, wherein the first relief angle is in a range of 83° to 88°.

3. The cutting tool according to claim 1, wherein the second relief angle is in a range of 79° plus/minus 2°.

4. The cutting tool according to claim 1, wherein the cutting edge, in plan view of the rake face, is a curved shape with a radius of curvature of 10 μm to 75 μm.

5. The cutting tool according to claim 1, wherein the workpiece is a lead-free, copper-based bearing alloy containing Cu: 75 to 95 percent by weight; Bi: 1 to 15 percent by weight; and hard particles composed of metal phosphide, metal boride, or metal carbide: 1 to 10 percent by weight.

6. The cutting tool according to claim 1, wherein the diamond tip is a sintered material formed including diamond particles having an average particle diameter (D50) of 0.2 μm to 1.6 μm.

7. The cutting tool according to claim 1, wherein a rake angle between the rake face and a direction perpendicular to a cutting direction of the cutting tool is in a range of +5° to −10°.

8. The cutting tool according to claim 1, wherein average particle diameter (D50) of the hard particles contained in the workpiece is in a range of 1 μm to 70 μm.

9. The cutting tool according to claim 1, wherein a distance between the boundary ridge and the rake face is in a range of 150 μm to 450 μm.
